(19) United States
(12) Patent Application Publication
(10) Pub. No.: US 2025/0073596 A1
(43) Pub. Date: Mar. 6, 2025

(54) METHOD AND APPARATUS PROVIDING A COMPUTER IMPLEMENTED GAME

(71) Applicant: KING.COM LIMITED, St. Julians (MT)

(72) Inventors: Lars Orblom, Stockholm (SE); Karin Bergvall, Stockholm (SE); Nashat Shah, Stockholm (SE); Mick Heijkens, Stockholm (SE); Sercan Caglarca, Stockholm (SE)

(21) Appl. No.: 18/459,546

(22) Filed: Sep. 1, 2023

(51) Int. Cl. A63F 13/69; G06F 3/0484; G06F 16/23

(52) U.S. Cl. CPC A63F 13/69; G06F 3/0484; G06F 16/23

(57) ABSTRACT

A method of controlling a graphical user interface, associated with a game, of a computing device is provided. The game comprises a first and second plurality of levels. The first plurality of levels comprises a first intersection level immediately preceding a first set of levels, and a second intersection level immediately succeeding the first set of levels. The second plurality of levels comprise a second set of levels provided in parallel to the first set of levels. Access to the second intersection level is granted on completion of either the first set or second set of levels. In response to determining that the user has completed the first intersection level, access is granted to a first level of the first set of levels and a first level of the second set of levels. At least a portion of the second set of levels is displayed on the graphical user interface.

### FIELD OF THE INVENTION

Embodiments of this disclosure relate to a method for controlling a graphical user interface associated with a game, and a computing device and computer program product for implementing the same.

Some embodiments may relate to engaging users or players in a computer implemented game executable in an online or offline environment.

### BACKGROUND OF THE INVENTION

In the field of computer-implemented games, there are many technical challenges facing the designer of such computer implemented games when considering how, for example, the user interface is to be controlled in the context of computer devices available to play the computer implemented game.

One technical challenge can involve allowing a game to be fun and compelling even when there is limited display resource available, such as when a computer implemented game is being played on a smartphone, tablet, or other minicomputer.

Another significant challenge is that of user engagement. Engagement involves designing gameplay to be engaging and rewarding to players. This typically requires games to be easily understood at their simplest or introductory levels, providing rewarding gameplay with quite simple game mechanics, but becoming progressively more challenging so that players are not bored, but remain engaged and develop rewarding skills. Effective engagement requires various forms of feedback to reinforce player sense of success and accomplishment.

A common genre of casual games is so-called match games. This is a type of tile-matching game where the player manipulates tiles or game objects according to a matching criterion.

A match-three game is a type of casual puzzle game where the player is required to find patterns on a seemingly chaotic board. The player then has to match three or more of the same type of game element on the game board and those matched elements will then disappear. An existing type of match-three game is a so-called “switcher” game. In a switcher game, the player switches place of two adjacent game elements on the game board so that one or both of them create a chain of at least three adjacent game elements of the same type. Those matched game elements will then disappear. The game board is then repopulated with game objects.

One such known match three-type game is Candy Crush Saga. In that game, the game board is repopulated with game elements which are perceived as falling downwards onto the game board from the top edge of the screen from which the computer implemented game is played.

Another known type of match game is “linker game,” where a sequence of game elements are linked to form a known sequence.

Another type of match game is a ‘clicker’ game, in which matches can be made in a board by clicking a group of adjacent game elements.

A technical challenge exists in the providing of effective user engagement in a match game which has a relatively simple game when played on a user device with a relatively small screen such as smartphone or tablet.

The Candy Crush Saga, and other games, can be played in Saga format. The Saga format is a format in which a plurality of levels of a game are arranged on a level a map. The level map may be divided into a plurality of episodes, each episode comprising a set of levels. A level selection screen may be displayed on the display of a user device, the level selection screen showing a set of levels for a user to play.

This patent specification describes not only various ideas and functions, but also their creative expression. A portion of the disclosure of this patent document therefore contains material to which a claim for copyright is made and notice is hereby given: Copyright King.com Limited 2023 (pursuant to 17 U.S.C. 401). A claim to copyright protection is made to all screen shots, icons, look and feel and all other protectable expression associated with the games illustrated and described in this patent specification.

The copyright owner has no objection to the facsimile reproduction by anyone of the patent document or the patent disclosure, as it appears in the Patent and Trademark Office patent file or records, but reserves all other copyright rights whatsoever. No express or implied license under any copyright whatsoever is therefore granted.

### SUMMARY OF THE INVENTION

According to a first embodiment, there is provided a method of controlling a graphical user interface of a computing device, wherein the graphical user interface is associated with a game being executed by a processor of the computer device, wherein the game comprises: a first plurality of levels comprising a first intersection level, a first set of levels, and a second intersection level, wherein the levels of the first plurality of levels are playable in a predetermined sequence, wherein the first intersection level immediately precedes the first set of levels and the second intersection level immediately succeeds the first set of levels; a second plurality of levels comprising a second set of levels, the second set of levels being playable in a predetermined order, wherein the second set of levels is provided in parallel to the first set of levels; wherein access to the second intersection level is granted on completion of either the first set of levels or the second set of levels; wherein the method comprises: determining that a user has completed the first intersection level; in response to determining that the user has completed the first intersection level, granting access to a first level of the first set of levels and a first level of the second set of levels; and displaying, on the graphical user interface, at least a portion of the second set of levels.

Access to a next level of the first set of levels may be granted on completion of the preceding level of the first set of levels, and wherein access to a next level of the second set of levels may be granted on completion of the preceding level of the second set of levels.

A player progression database may store player data associated with the user, wherein the method may further comprise accessing the player progression database and determining that the user has completed the first intersection level based on the stored player data.

The player progression database may store, in association with each level, a completion status, the completion status being set to: incomplete when the respective level has not been completed; and completed on completion of the respective level; wherein it is determined that the user has completed the first intersection level based on the completed completions status stored in association with the first intersection level in the player progression database.

The method may further comprise: determining that the user has completed the final level of the second set of levels; storing, in the player progression database, a completed completion status in association with the final level of the second set of levels; and storing, in the player progression database, a completed completion status in association with each level of the first set of levels.

The method may further comprise: receiving, at the graphical user interface, player inputs from the user engaging with a level of the game to enable the game to determine when that level has been completed by the user and to generate first player data indicating the level of the game that the user is engaged with; determining that the user is engaged with the second set of levels; obtaining second player data associated with a second user engaged with the second set of levels, the second player data indicating the level of the second set of levels that the second user is engaged with; displaying, on the graphical user interface, a visual representation of relative positions of the first user and the second user in the second set of levels based on the first player data and the second player data.

A player progression database may store player data associated with the user and the second user, wherein the method may further comprise accessing the player progression database to obtain the second player data.

The method may further comprise: obtaining a user identifier of a social contact of the user, wherein the social contact is the second user; obtaining the second player data stored in the player progression database in association with the user identifier of a social contact.

The second set of levels may be made available for access during a predefined time period only, wherein the method may further comprise, in response to determining that the user has completed the first intersection level, determining that the second set of levels is currently available for access; wherein access is granted to the first level of the second set of levels in response to determining that the second set of levels is currently available for access.

The first plurality of levels may comprise a third intersection level, a third set of levels, and a fourth intersection level, wherein the third intersection level immediately precedes the third set of levels and the fourth intersection level immediately succeeds the second set of levels; and the second plurality of levels may comprise a fourth set of levels, the fourth set of levels being playable in a predetermined order, wherein the fourth set of levels is provided in parallel to the third set of levels; wherein access to the fourth intersection level may be granted on completion of either the third set of levels or the fourth set of levels; wherein the method may further comprise: determining that the user has completed the third intersection level; in response to determining that the user has completed the first intersection level: granting access to a first level of the third set of levels; determining that the user has completed the second set of levels; and in response to determining that the user has completed the second set of levels, granting access to a first level of the fourth set of levels; and displaying, on the graphical user interface, at least a portion of the fourth set of levels.

The second set of levels may be made available for access during a first predefined time period only, wherein the fourth set of levels may be made available for access during a second predefined time period only, wherein the second predefined period is shorter than the first predefined time period and the second predefined time period overlaps with the first time period, wherein the method may further comprise, in response to determining that the user has completed the first intersection level, determining that the second set of levels is currently available for access; wherein access is granted to the first level of the second set of levels in response to determining that the second set of levels is currently available for access.

The first plurality of levels may comprise a set of episodes, each episode comprising a predefined number of levels and playable in a predefined order, wherein a first episode comprises the first intersection level, the first set of levels, and the second intersection level, wherein a second episode comprises a third intersection level, a third set of levels, and a fourth intersection level, wherein the third intersection level immediately precedes the third set of levels and the fourth intersection level immediately succeeds the third set of levels, wherein the method may further comprise: determining that the user has completed the third intersection level; in response to determining that the user has completed the third intersection level: granting access to a first level of the third set of levels; determining that the user has not completed the second set of levels and, in response, granting access to at least one level of the second set of levels; and displaying, on the graphical user interface, at least a portion of the second set of levels.

The method may further comprise, in response to determining that the user has not completed the second set of levels: determining a highest level of the second set of levels completed by the user, wherein a highest level of the set of levels is the level of the set of levels which is accessible last in the sequence of levels; and granting access to a level of the second set of levels immediately succeeding the highest level of the second set of levels completed by the user.

The method may further comprise: receiving a user interaction at the graphical user interface with one of the levels of the second set of levels; determining that access has been granted to the level with which the user has interacted; and in response to determining that access has been granted, providing a game level associated with the level at the graphical user interface.

The method may further comprise: determining a difficulty bracket based on a highest level of the first plurality of levels to which the user has been granted access; and modifying a difficulty level of the game level based on the difficulty bracket; wherein the game level is provided at the graphical user interface with the modified difficulty level.

According to another aspect, there is provided a computer device configured to provide a computer implemented game, the computer device comprising a display, a user interface, at least one memory, and at least one processor, wherein the game comprises: a first plurality of levels comprising a first intersection level, a first set of levels, and a second intersection level, wherein the levels of the first plurality of levels are playable in a predetermined sequence, wherein the first intersection level immediately precedes the first set of levels and the second intersection level immediately succeeds the first set of levels; a second plurality of levels comprising a second set of levels, the second set of levels being playable in a predetermined order, wherein the second set of levels is provided in parallel to the first set of levels; wherein access to the second intersection level is granted on completion of either the first set of levels or the second set of levels; wherein the at least one processor is configured to: determine that a user has completed the first intersection level; in response to determining that the user has completed the first intersection level, grant access to a first level of the first set of levels and a first level of the second set of levels; and display, on the graphical user interface, at least a portion of the second set of levels.

According to a third aspect, there is provided a non-transitory computer program product comprising instructions which, when implemented by a at least one processor, cause a computing device to be configured to control a graphical user interface of the computing device, wherein the graphical user interface is associated with a game being executed by a processor of the computer device, wherein the game comprises: a first plurality of levels comprising a first intersection level, a first set of levels, and a second intersection level, wherein the levels of the first plurality of levels are playable in a predetermined sequence, wherein the first intersection level immediately precedes the first set of levels and the second intersection level immediately succeeds the first set of levels; a second plurality of levels comprising a second set of levels, the second set of levels being playable in a predetermined order, wherein the second set of levels is provided in parallel to the first set of levels; wherein access to the second intersection level is granted on completion of either the first set of levels or the second set of levels; wherein the computer program product causes the computing device to: determine that a user has completed the first intersection level; in response to determining that the user has completed the first intersection level, grant access to a first level of the first set of levels and a first level of the second set of levels; and display, on the graphical user interface, at least a portion of the second set of levels.

### BRIEF DESCRIPTION OF THE DRAWINGS

Embodiments will now be described by way of the accompanying drawings in which:

FIG. 1 shows an example user device configured to provide some embodiments;

FIG. 2 shows an example system in which some embodiments may be provided;

FIG. 3 shows an example of a level selection screen;

FIG. 4 shows an example adventure path;

FIG. 5 provides an example method for rendering a level selection screen;

FIG. 6 provides an example method for tracking user progress;

FIG. 7 provides an example player progression database;

FIG. 8 shows an example user interface for accessing the adventure path;

FIG. 9 shows an example user interface for allowing a user to access adventure path levels; and

FIG. 10 shows a diagram of an example communication system.

### DESCRIPTION OF PREFERRED EMBODIMENTS

The terms user and player are used interchangeably throughout this document and no specific meaning is intended using one or the other unless the context suggests otherwise.

In the following description of various implementations of the embodiments, reference is made to the accompanying drawings which form a part thereof, and in which is shown by way of illustration various implementations in which the invention may be utilized. It is to be understood that other implementations may be utilized, and structural and functional modifications may be made without departing from the scope of the present invention.

A person skilled in the art will realise that the different approaches to implementing the computer implemented game is not exhaustive, what is described herein are certain preferred embodiments. It is possible to implement the computer implemented game in a number of variations.

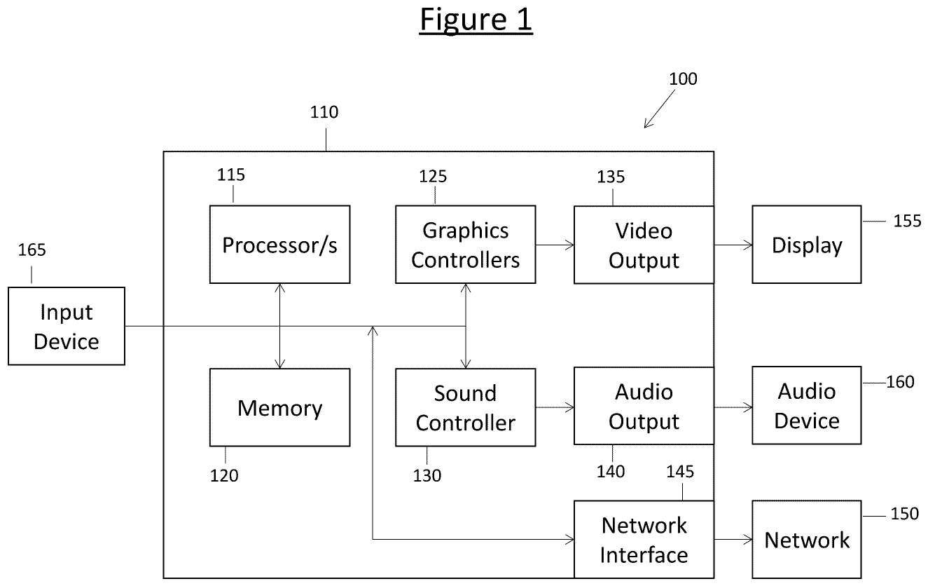

A schematic view of a user device 100 according to an embodiment is shown in FIG. 1. All of the blocks shown are implemented by suitable circuitry. The blocks may be implemented in hardware and/or software. The user device may have a control part 110. The control part 110 is shown as having a graphics controller 125 and a sound controller 130. It should be appreciated that one or other or both of the graphics controller 125 and sound controller 130 may be provided by the one or more processors 115.

The graphics controller 125 is configured to provide a video output 135. The sound controller 130 is configured to provide an audio output 140. The control part 110 has an interface 145 allowing the device to be able to communicate with a network 150 such as the Internet or other communication infrastructure.

The video output 135 is provided to a display 155. The audio out 140 is provided to an audio device 160 such as a speaker and or earphone(s).

The device 100 has an input device 165. The input device can take any suitable format and can be one or more of a keyboard, mouse, touch screen, joystick, or game controller. It should be appreciated that the display 155 may in some embodiments also provide the input device 165 by way of an integrated touch screen for example.

The blocks of the control part 110 are configured to communicate with each other by an interconnect such as a bus or any other suitable interconnect and/or by point-to-point communication.

It should be appreciated that in some embodiments, the control part may be implemented by one or more integrated circuits, at least in part.

The user device 100 is shown by way of example only. In alternative embodiments, one or more of the parts may be omitted. Alternatively or additionally, some embodiments may comprise one or more other parts. Alternatively or additionally, one or more parts may be combined.

In some embodiments, the user device is configured to provide a computer implemented game of some embodiments. This is described in more detail later.

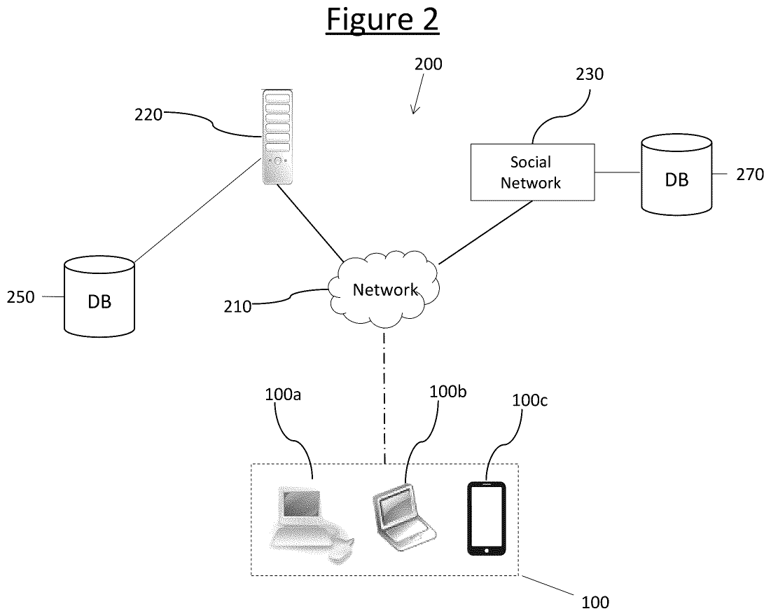

FIG. 2 schematically shows a system 200 supporting some embodiments. The system 200 comprises a server 220 which may store or be in communication with a database 250 which may store game player's details, profiles, statistics etc. In practice, one or more databases 250 may be provided. Where more than one server 220 is provided, the database(s) 250 may be provided in one server 220 or across two or more servers. The server 220 may also have a games data function. This may comprise one or more units of memory to store the computer implemented game program and user behaviour data, and a processor to run the games program and process the user behaviour data.

The server 220 may communicate via, for instance, the internet 210 with one or more client or user devices 100, shown in FIG. 2 by way of example as user devices 100a, 100b and 100c. There may be connections, via the network 210, to a social network 230, for example, Facebook™. The social network 230 may also be connected to a database 270 storing for example, social user interaction details, user to user interaction maps, friend lists, location history, and/or the like. In practice, one or more databases 270 may be provided.

It should be appreciated that embodiments may be deployed in different system architectures. For example, the computer implemented game may be implemented as a computer implemented game that is stored in the memory of the user device and is run on the at least one processor of the user device. However, the server 220 may handle some elements of the computer implemented game in some embodiments. By way of example only, a Java game applet may be provided to the user device 100 and the locally running Java applet will generate, for example, the graphics, sounds, and user interaction for the game play on the user device. Some data may be fed back to the server to allow interaction with other players. The data which is fed back may alternatively or additionally allow scoring and/or cross platform synchronization.

In some embodiments, the computer implemented game may be implemented as a computer program that is stored in a memory of the system, for example the server, and which runs on at least one processor of the game server. Data streams or updates are supplied to the user device to allow the user device to render and display graphics and sounds in a browser of the user device. Such an approach is sometimes referred to as a web services approach. It should be appreciated, however, that such an approach does not necessarily require the use of the Internet.

It should be appreciated that some embodiments may be provided as a stand-alone computer implemented game on the user device.

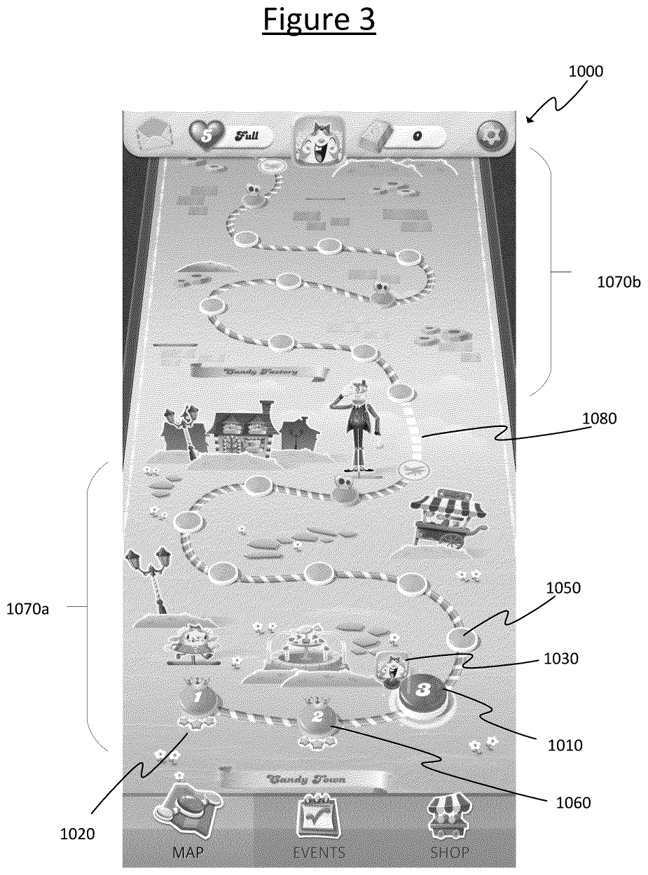

FIG. 3 illustrates a level selection screen 1000 which is rendered on the display of a user device 100 to a first player. The level selection screen 1000 shows a set of levels, each of which is represented by a node, for example node 1010, presented on a game path. The player marker indicators 1020 provide a count of star-shaped markers. Each star-shaped marker denotes the fact that the user has achieved a particular game objective in a particular game mode at that location. On the level selection screen 1000, a player icon 1030 is shown, indicating the game progress of the first user. When the first user starts the game, this icon 1030 is shown at the node that is the furthest level along the game path that the user has not yet completed. Beyond this node 1010 are a series of other nodes, e.g. node 1050, which represent levels which the first user has not yet unlocked, and hence cannot be played yet by the first user. On the other hand, before the node 1010 are a series of nodes, e.g. node 1060, which represent levels which the first user has played and completed. The first user may select one of these levels to play again. In response to a user input associated with a node, the level associated with that node may be loaded for play by the first user. The user input associated with the first node may comprise a mouse click or touch screen input at the location of the relevant node.

The levels are separated into groups, referred to as episodes. Two episodes 1070a, 1070b are shown on the level selection screen 1000. The episodes 1070a, 1070b are represented visually by a break 1080 in the path provided on the level selection screen 1000. The number of levels in an episode is predefined. There are 10 levels in the episodes 1070a, 1070b shown in FIG. 3. Below, episodes are assumed to have 15 levels. An average difficulty of the levels increases as the player progresses through the levels, and the difficulty of a next level may be greater or lesser than that of the preceding level. Difficulty across progression is relative to the players in that progression and might be perceived differently by players.

A series of identifiers or icons of other users (not shown) may also be provided on the level selection screen. The position of these identifiers indicates the progress of the relevant user in the game. For example, the position of the identifier of the other user may indicate the furthest level along in the progression path, which the other user has unlocked but not completed. The terminal of the first user may be configured to receive the progress information of one or more other users who are participants in the game, and to display this information on the level selection screen 100, wherein the progress is indicated by the position of the identifier 140 along the level path. The progression of the other players is maintained centrally such that it can be represented on the first player's level selection screen 1000.

Players are provided with an alternative route, referred to herein as an adventure path, via which they can progress through the game. The adventure path provides alternative levels for the users to play. The adventure path levels are divided into sets, referred to as chapters, which are provided in parallel to the game path. In some embodiments, there are 40 levels in the adventure path, with 5 levels in each chapter.

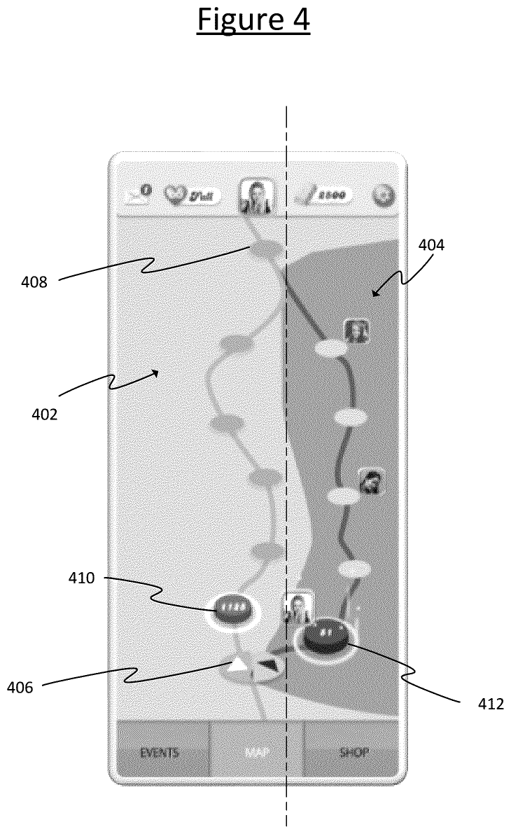

FIG. 4 provides an example adventure path 404. The adventure path 404 is shown in parallel to the main game path 402. The adventure path 404 comprises 5 levels. The adventure path 404 connects to the main path 402 at intersection nodes 406, 408.

A player progresses along the game path 402 as described above with reference to FIG. 3. When the player completes the level associated with a first intersection node 406, the player can choose to either continue along the main path, to node 410, or to travel along the adventure path 404, moving to node 412.

The adventure path 404 is traversed in a similar manner to the game path 402, as described above. That is, the user selects an unlocked node which causes the associated level to be loaded. On completing the level, a next node, and thus level, along the path is unlocked.

Once the user has completed all levels of the adventure path 404, the user re-joins the main game path 402 at a second intersection node 408. The user's progress along the adventure path 404 is then mapped to the main path 402. That is, the levels between the intersection nodes 406, 408 are marked as completed. Thus, the adventure path 404 provides an alternative route for progressing through the game.

The player may choose to play some levels of the adventure path 404, but not all. For example, the player may play the first two levels of the adventure path 404, but be unable to complete the third level. The player can then choose to return to the main path 402. However, since the player has not completed the adventure path, the player must play all levels of the main game path 402. The player returns to the game path 402 and plays the next unlocked level, associated with node 410. That is, the player's progress on the adventure path 404 is only mapped to the main path 402 if the player completes all levels of the adventure path 404.

The adventure path therefore provides a user with an alternative route for progressing through the saga map, which may be useful to the user if they are unable to complete the levels of the main game path 402.

The adventure path is an event which is available for a predefined time period. If active, a next available chapter is provided to the user on their level selections screen. The chapters of the adventure path are independent of episode. Therefore, if there is an available chapter, the player will be presented with the adventure path chapter irrespective of the episode they are currently playing. The adventure path feature provided herein provides the possibility for delivering an alternative group of (e.g., 40) levels irrespective of where players are in their progression in the main saga.

Chapters for the adventure path can become available at different times. In the embodiment provided herein, a new adventure path starts every season, with each season mapping to a month of the year. New chapters are made available every week, with 2 chapters being made available each week. A next chapter of the adventure path, that is the next set of levels, is only unlocked by completing the previous chapter, and provided it has been made available. It will be appreciated that the time periods and number of chapters available given herein are provided by way of example only. In some embodiments, all chapters are made available at the same time. In other examples, the intervals between chapter releases are varied. In this way, new levels are made available to players irrespective of their progression along the main Saga map. This allows newer users, or those who play less frequently, to experience new game mechanics or features which would otherwise only be included in new levels provided at the end of the saga map. Moreover, since the adventure path chapters are released at different times and adventure paths themselves are only temporary, and thus each adventure path level is only available for a limited time, the adventure path provide time limited goals and so user engagement is improved.

Each chapter is provided at the same relative location in an episode. In the embodiment provided herein, the chapter is provided in parallel to the 6th to 10th levels of an episode. A player may choose not to play any of the adventure path levels, or only some of the adventure path levels. In this case, when the player starts a new episode, the previously presented adventure path chapter is presented again.

Any progress of the player within a chapter is retained. In this way, if a player does not complete a chapter in one episode, but does complete some of the levels of the chapter, when the chapter is next provided to the player in the next episode, the previously completed levels of the chapter are presented as completed.

It will be appreciated that the number of levels in an adventure path or chapter, and the number of chapters in the adventure path used herein are provided by way of example only, and other numbers of these parameters are possible. For example, the adventure path may be a single level, provided as a means for a player to bypass one level of the main game path. In other embodiments, there is only one chapter, such that the user can use the adventure path as an alternative route only once during the time for which the adventure path is active. In other embodiments, there are different numbers of levels in each chapter of the adventure path, and/or each chapter may be provided in parallel to a different set of levels of the main saga map. In some embodiments, the number of levels in the chapter and the number of levels of the main saga map bypassed by the chapter may be unequal.

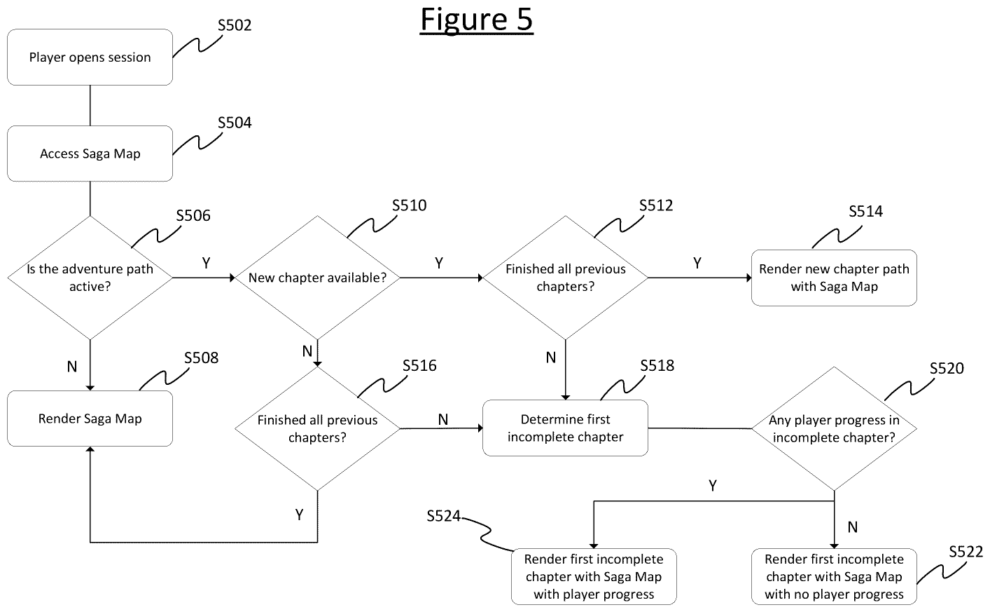

FIG. 5 shows an example method for rending the level selection screen 1000. At step S502, the player opens a gameplay session. This may be the player opening an app on their user device 100 or the user accessing a webpage, thereby accessing a user interface of the game. The user selects, via the user interface, to view the level selections screen 1000.

The saga map, or game path 402, is accessed from a database or other memory store at step S504. As described later, the game may be played on-or off-line. The game path 402 may be stored locally at the user device such that the user can continue to play the game while the user device 100 is offline. Alternatively or additionally, the game path 402 may be stored online, such that the game path 402 is accessed from an online database when the device 100 is online.

It is then determined, at step S506, if an adventure path is active. Adventure paths may only be active during predefined time periods, for example. The adventure paths may therefore be considered temporary. If there is no active adventure path, the saga map is rendered on the level selection screen 1000, step S508.

If, however, there is an active adventure path, it is then determined if a new chapter is available at step S510. A new chapter refers to a chapter which has been made available since the player last accessed the saga map.

If there is no new chapter, it is determined at step S516 if the player has finished all previously available chapters. That is, if the player has completed all levels of the adventure may which are currently available to be played. If the player has completed all previously available chapters, the game path is rendered alone, step S508.

If instead, at step S510, it is determined that there is a new chapter available, it is next determined at step S512 is all previously available chapters have been completed. That is, it is determined if the user has completed all levels of the adventure path before the newly available ones. If the next incomplete level available for the user to play is in the newly available chapter, the new chapter is accessed from the database and provided together with the game map 402 on the level selection screen 1000, step S514.

If it is determined at either step S512 or step S516 that the player has not finished all previously available chapters, a first incomplete chapter is determined at step S518. The first incomplete chapter is the earliest chapter for which the user has not completed all levels, where chapter 1 is the earliest chapter of the chapters of the adventure path. It is then determined at step S520 if the user has completed any of the levels of the earliest incomplete chapter. If the user has not completed any of the levels of the chapter, the earliest incomplete chapter is accessed from the database and provided with the main game map on the level selection screen 1000 with none of the levels shown as completed. If instead the user has completed one or more of the levels of the chapter, the earliest incomplete chapter is rendered with the main game map and showing the complete chapters of the chapter as completed.

The chapter rendered available to the user may be referred to as a playable chapter. The chapter is playable since the user has completed the previous levels of the adventure path, thereby unlocking at least the first level of the chapter, and the chapter has been made available.

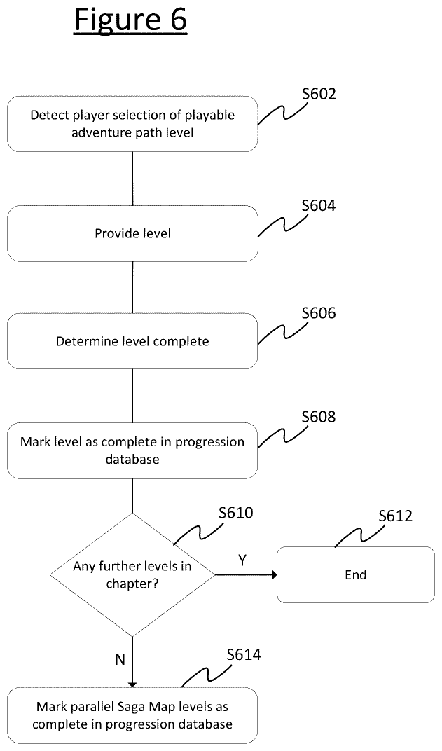

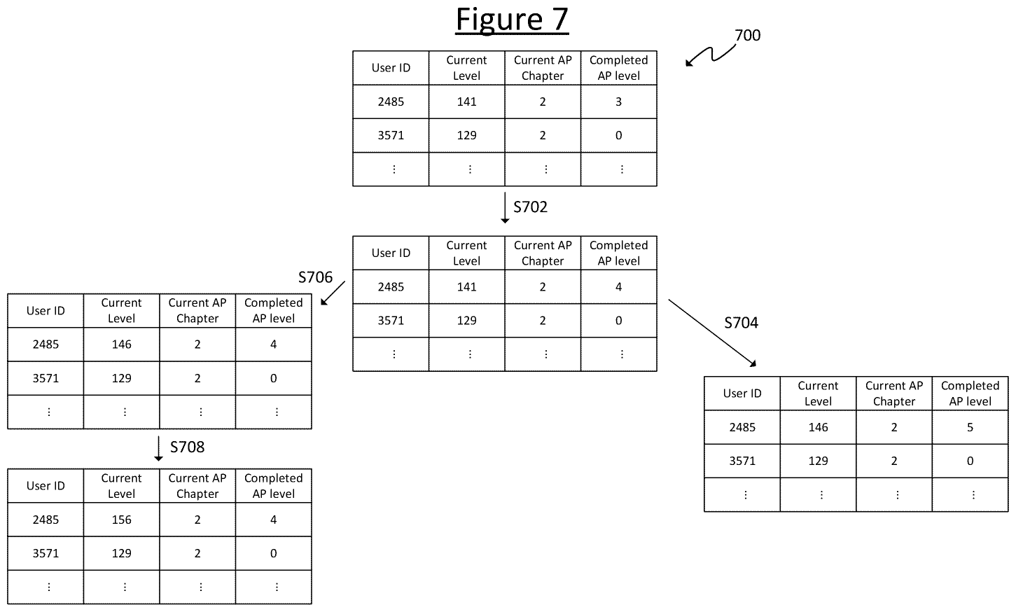

Once the playable adventure path chapter 404 has been rendered to the user, the user can choose to play the unlocked levels of the chapter. FIG. 6 provides an example method for tracking user progress through the levels, and FIG. 7 provides an example player progression database 700 for maintaining user progress.

A user input is detected at step S602 selecting a playable level, that is a level that is unlocked, or to which the player has been granted access. The user selects the level to be played by selecting the node of the map associated with the level. The level is then provided to the user for playing at step S604.

The user plays and completes the level. It is determined that the user has completed the level at step S606. The user completes the level by fulfilling one or more level completion requirements, such as collecting a predefined number of point or destroying a predefined number of game blocks. The player progression database 700 is updated at step S608 to indicate that the player has completed the level.

At step S610, it is determined if the are any further levels of the chapter which the user has not completed, that is if the user has completed the chapter or not. If the user has not completed the chapter and there are levels remaining, the process ends, step S612. If the user has finished the chapter, the levels of the main saga map bypassed by the adventure path are marked as complete in the user progression database 700, step S614.

When the completed levels of the adventure path are mapped to the main saga path levels, the player may be awarded other benefits for completing the levels via the adventure path. For example, the player may be considered to have achieved all game objectives associated with each of the bypassed levels of the main saga path, such that all three stars of the player marker indicators 1020 are shown as completed. Alternatively, game objectives achieved in the adventure path may be mapped to the corresponding levels of the main saga path. Alternatively or additionally, the player may be awarded special booster game elements or game currency for completing the adventure path chapter. The players are may be awarded a further, larger, reward for completing all chapters of the adventure path.

Referring to FIG. 7, the user progression database 700 comprises a user ID field, a current level field, a current AP (adventure path) chapter, and a completed AP level. The progression database 700 is maintained centrally at a game server accessible to all user devices 100 when online. A local copy of the user progression database 700 may be stored at the user device 100 such that a user's progress can be recorded when the user plays offline. The central and local copies of the database 700 synchronise when a user device 100 next goes online. The local copy of the progression database 700 may only store data associated with the user. It may also store data associated with friends of the user. Friends are discussed in more detail below. In summary, friends are other players with whom the user has connected via the game.

Progression data associated with two users is provided in the progression database 700 of FIG. 7. In FIG. 7, the second user, with ID 3571, does not complete any levels. The data is provided by way of example only.

The first user, with ID 2485, has a current level of 141. The current level is the highest unlocked level of the main game path that the user is eligible to play. The first user is current eligible to play adventure path chapter 2, as indicated by the current AP chapter field. The user has therefore completed chapter 1, and chapter 2 is available for users to play. The user has completed level 3 of chapter 2, as indicated by the complete AP level field.

At step S702, the first player completed level 4 of chapter 2 of the adventure path, and the completed AP level field is updated to reflect the level completion.

The user may then complete level 5 of the chapter, thereby completing the chapter. This is reflected in the database update at step S704, in which the completed AP level is updated to 5, and the current level field is updated to 146. That is, the completed adventure path levels are mapped to the levels of the main saga path.

The player may be unable to complete level 5 of the chapter, or may decide to complete the levels on the main saga path. The player must complete each level of the saga path as they have not completed the chapter. The database 700 is updated with every level the user completes. The progress of the user in the adventure path is maintained.

At step S706, the user has played and completed each of levels 141, 142, 143, 144, and 145 of the main saga path, as represented by the updated current level field. The current AP chapter field and the completed AP level field remain the same.

The user reaches an intersection node in the next episode, corresponding to level 156, as shown by the database update S708. The user is presented with the chapter 2 path, with each of levels 1 to 4 marked as completed. The user therefore only needs to complete level 5 of chapter 2 to progress to level 161 of the main saga path.

It will be apparent that steps S706 and S708 represent the result of multiple incremental database updates based on the user completing multiple levels.

The player progression database 700 may comprise additional or alternative fields. For example, there database 700 may comprise one or more fields associated with each level. These fields may store a completion status for the level and/or a score achieved by the player for the level.

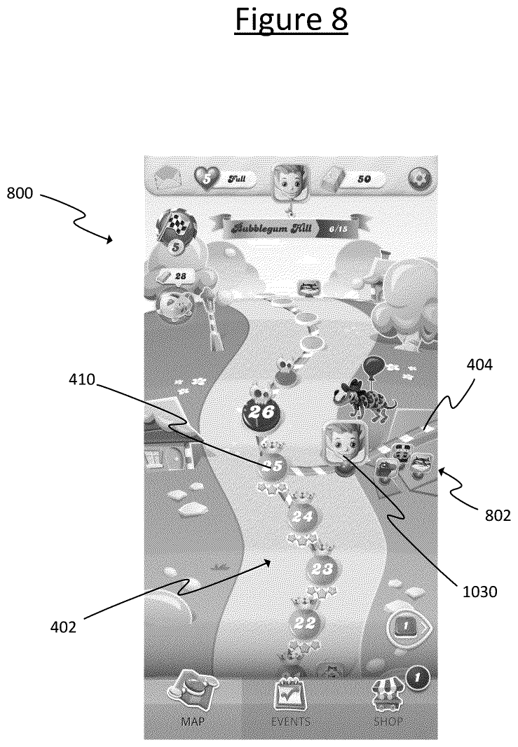

FIG. 8 shows an example level selection screen 800 once an adventure path chapter is available. A portion of the adventure path 404 is shown to branch from the main game path 402 at the first intersection node 410, which the user has completed.

Only a portion of the adventure path 404 is provided on the level selection screen 800 so that the main game path 402 does not need to be resized or scaled if an adventure path is available.

If the player chooses to play the adventure path chapter, for example by selecting the rendered portion of the adventure path 404 or by agreeing via a pop-up message for example, the player icon 1030 starts to move along the adventure path 404, as can be seen in FIG. 8. The player represented by the player icon 1030 is referred to as the first player, and is the player whose device is rendering the level selection screen 800.

To further engage players, they are able to see their friends who are also attempting to complete the same adventure path chapter. There are currently over 10,000 levels of Candy Crush available, with player located over the length of the game. Therefore, is it likely that a player will be at a different part of the saga to their friends and thus would not see their progress while travelling along the main saga path.

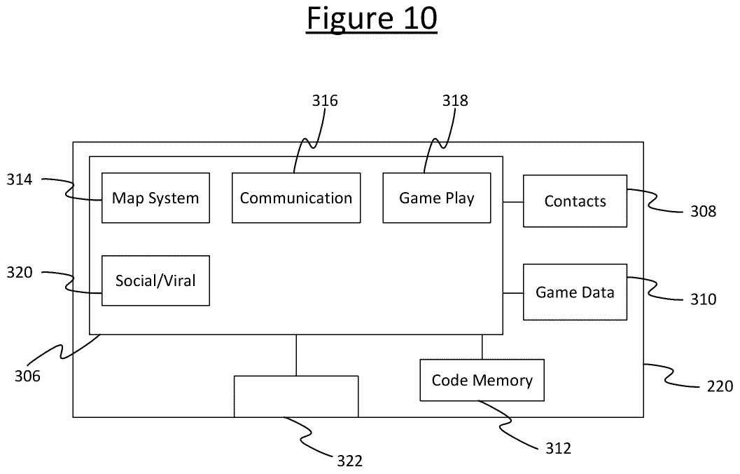

Three other user icons 802 can be seen on the rendered part of the adventure path 404. These other user icons 802 represent friends of the first player who are also playing the adventure path chapter. The other users may be a social network contact/friend of the first player who play the game on separate terminals or user devices. The other users may be located remotely from the first player, with their devices 100 communicated via a network, as described later with reference to FIG. 10.

Player data corresponding to the other players, represented by other user icons 802, may be obtained from the player progress database 700. Friends of the first player who have a current AP chapter matching that of the first player and have not completed the chapter, are represented visually on the adventure path 404.

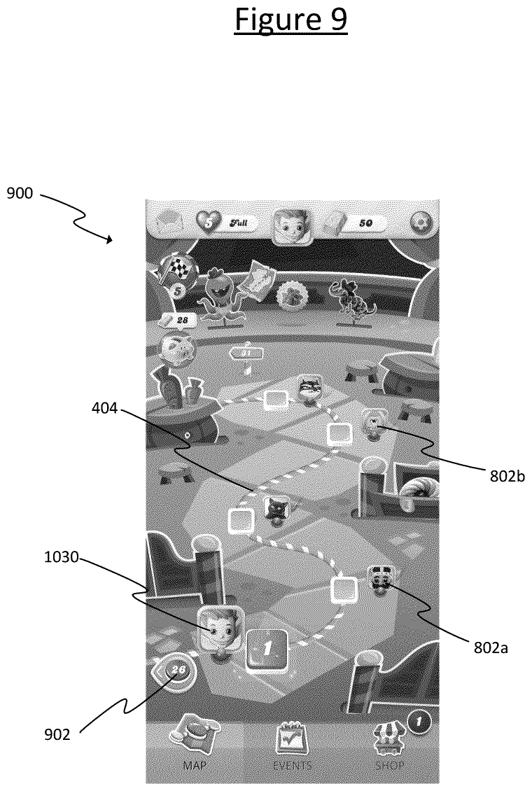

FIG. 9 shows a level selection screen 900 showing the adventure path 404. The adventure path 404 comprises 5 nodes representing the 5 levels of the chapter. The player icon 1030 is shown at the first node of the adventure path 404, indicating that the first player has not completed any of the levels of the adventure path.

The other user icons 802 are located next to nodes of the adventure path 404 corresponding to the highest level unlocked by the corresponding player. The highest unlocked level is determined from the completed AP level field of the player progression database 700. For example, the player associated with player icon 802a, located next to the second node of the adventure path 404, would have a completed AP level value of 1 since they have completed the first, but not the second, level of the adventure path chapter. Similarly, the player represented by player icon 802b, located at the fourth node of the adventure path, would have a completed AP level value of 3 stored in the player progression database 700.

As the first player progresses through the levels of the adventure path chapter, the player icon 1030 moves along the adventure path 404. Similarly, as the other players, represented by player icons 802, complete levels of the adventure path chapter, their corresponding icon 802 moves along the adventure path 404.

If the user device 100 is online, any changes to the progression of the other players may be pushed to the user device 100 from a central game server maintaining a master copy of the player progression database 700 to the user device 100. Alternatively, the user device may pull updates of the player progression database 700 from the central game server at predefined intervals. This push/pull of data may be referred to as synchronisation of the local and central progression databases 700. During synchronisation, any progress of the first user recorded at the user device 100 us also mapped at the central game server at the central play progression database. If the user device 100 is offline, the other player icons 802 remain at the nodes corresponding to their highest unlocked level at the time of the last database 700 synchronisation.

The other players represented on the adventure path 404 are social contacts of the first player. These may be, for example, friends of the first player on social media platforms, or contacts stored on the user device or a messaging or email service. A user identifier of the player's social contact is obtained, and used to retrieve player data stored in association with the user identifier from the player progression database 700.

The level selection screen 900 also comprises a main path return selectable item 902, which the user can select to return to the level selection screen 800 showing the main game path 402 via which the user can play the levels corresponding to the main game path 402.

As described above, the adventure path may comprise 40 levels split into 8 chapters, with chapters being independent of episode. Players can, therefore, participate in the same adventure path as friends who are currently at a different stage in the main game path, and would otherwise not be visualised on their game path. This creates an inclusive, social experience for the players.

Along the main saga map, the difficulty of the levels increases. It is therefore expected that players who have progressed further along the path are more skilful than those who have not progressed as far. To ensure the levels provided in the adventure path are engaging for users, the difficulty of the level may be modified for each user. Users are more engaged with levels which are challenging but achievable. There may be a predefined number of level brackets, for example there may be 3, 4, or 5 different level brackets. The levels of the main saga map are divided into these brackets. Each bracket has a defined difficulty level associated with it. When a user player an adventure path level, the difficulty of the adventure path level is chosen based on the bracket into which their current main game path level falls into. Any respective adventure path level is of the same type, but is provided to users with a tailored difficulty. In this way, the difficulty of the adventure path levels are given such that the challenge is relevant to each player's progress or engagement level. Difficulty can be varied in a number of ways which will be apparent, for example varying game parameters such as an allowed time or a target number of items to collect.

Thus, the adventure path provides a similar experience to all users, irrespective of their progression on the main Saga path.

When a player completes an adventure path chapter, there may be a social celebration provided. For example, players may be able to send messages or game elements to other players when they themselves or the other player completes the chapter.

There may be events located on the main saga map which, when a player reaches the location on their path, the user is eligible to partake in. So as not to cause a user to avoid an adventure path in order to participate in an event on the adventure path, the locations of the events are mapped to the same location on the adventure path. For example, an event located after a 12th level of an episode is mapped to after the 2nd level of the adventure path chapter.

FIG. 10 is a schematic diagram of a game server 220 which communicates via the communication network 210 with user devices 100 as described with reference to FIG. 2. The server has a processor 306 which can be implemented by one or more processing units. Furthermore, the functionality to be explained with respect to the processor 306 in the game server 220 could in reality be carried out in a distributed fashion amongst multiple servers, or even between the local user devices and the server. The present description is for ease of reference only in describing the functionality, and assumes that the game is implemented at the server, e.g. in a web-based architecture. When the game is implemented at a local device, the modules are provided at the local device. The server 220 also comprises electronic storage in the form of computer memory. Two particular types of data are shown stored in separate computer memories-a contact memory 308 and a game data memory 310. However, it will be readily appreciated that these could be in the same or different memories, or indeed located at memories remote from the server and accessible thereto.

When implemented at the server, the processor 306 in combination with the memories 308, 310 implements the modules which are shown in the processor 306. These modules are implemented by computer code sequences which are executed by the processor 306. These code sequences can be stored in a code memory 312, at the server, or in any suitable place. When implemented at a local device, the modules are provided by a client which provides code sequences stored in a local memory. In that case, the server provides event data for events generated locally as described later.

“Play” is provided by providing executable computer code to the user device, with a game mode object (node) for display on the map which renders the computer code accessible to a player when they select the game mode object on the map.

The server provides the normal function of a game server. That is, it has a network interface 322 which communicates with the communication networks 302 and via which a game executable can be downloaded to the user devices 304. A user may download a game executable at the time that they log on, or at subsequent log-in occasions. They may download a game executable once, and then receive updates at subsequent log-ins. The executable will contain information for rendering a map (the level selection screen) for that user, and game logic for allowing the user to play the game on or off-line. For mobile devices, a game executable contains all the modules for playing the game offline, requiring access to the server only for event data. The map system 314 is responsible for generating for each user, a level map showing the levels that a user is able to play. A user can scroll through the map in on-line or off-line play. The map system module 314 may also be responsible for rendering the theme of the level selection screen. The map system module 314 may also be capable of causing dynamic events to be rendered. These dynamic events depend on game data received from the user devices, and to achieve this the map system module 314 interacts with the gameplay module 318. The adventure path as described herein may be considered a dynamic event. The map system module 314 is also responsible for generating new animations-these are animated icons which are rendered to a user on his display illustrating what has happened since the last time the user logged in. The map system module 314 is also responsible for rendering an endgame view, when all markers have been achieved at all levels.

The map system module 314 may also be responsible for notifying the friends of a user about that user's progress. This is a two way function. Firstly, it advises a particular user about the progress of the user's friends by showing the location of their most recent achievements. In this way, the achievements of active friends are highlighted. In addition, it provides to the friends of that user information about the current user's progress, similarly showing it on an animated map of those friends. To achieve this, it requires access to the contact memory 308, which holds contacts for each particular user. The client can download data from the server. The client keeps a list of the logged in user's friends. The list entries contain information such as user id, name, e-mail, avatar (where available) etc. In addition, a list of the aggregated progression of all friends is kept.

Various methods and devices have been described. It should be appreciated that these methods may be implemented in apparatus or devices comprising any suitable circuitry. Some embodiments may be implemented by at least one memory and at least one processor. The memory is provided by memory circuitry and the processor is provided by processor circuitry. Some embodiments may be provided by a computer program running on the at least one processor. The computer program may comprise computer implemented instructions which are stored in the at least one memory and which may be run on the at least one processor. A computer program product may be provided which comprises computer program product comprising code embodied on a computer-readable medium which is configured to be executed on a processor of the computer or user device. In some embodiments, a non-transitory computer readable storage device may be provided to store program code instructions that, when executed by at least one processor causes any of the above described methods to be performed.

A person skilled in the art will realise that the different approaches to implementing the computer implemented game is not exhaustive, what is described herein are certain preferred embodiments. It is possible to implement the way in a number of variations without departing from the scope of the invention as claimed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method of controlling a graphical user interface of a computing device, wherein the graphical user interface is associated with a game being executed by a processor of the computer device, wherein the game comprises:
a first plurality of levels comprising a first intersection level, a first set of levels, and a second intersection level, wherein the levels of the first plurality of levels are playable in a predetermined sequence, wherein the first intersection level immediately precedes the first set of levels and the second intersection level immediately succeeds the first set of levels;
a second plurality of levels comprising a second set of levels, the second set of levels being playable in a predetermined order, wherein the second set of levels is provided in parallel to the first set of levels;
wherein access to the second intersection level is granted on completion of either the first set of levels or the second set of levels;
wherein the method comprises:
determining that a user has completed the first intersection level;
in response to determining that the user has completed the first intersection level, granting access to a first level of the first set of levels and a first level of the second set of levels; and
displaying, on the graphical user interface, at least a portion of the second set of levels.

2. The method of claim 1, wherein access to a next level of the first set of levels is granted on completion of the preceding level of the first set of levels, and wherein access to a next level of the second set of levels is granted on completion of the preceding level of the second set of levels.

3. The method of claim 1, wherein a player progression database stores player data associated with the user, wherein the method further comprises accessing the player progression database and determining that the user has completed the first intersection level based on the stored player data.

4. The method of claim 1, wherein the player progression database stores, in association with each level, a completion status, the completion status being set to:
incomplete when the respective level has not been completed; and
completed on completion of the respective level;
wherein it is determined that the user has completed the first intersection level based on the completed completions status stored in association with the first intersection level in the player progression database.

5. The method of claim 4, wherein the method further comprises:
determining that the user has completed the final level of the second set of levels;
storing, in the player progression database, a completed completion status in association with the final level of the second set of levels; and
storing, in the player progression database, a completed completion status in association with each level of the first set of levels.

6. The method of claim 1, wherein the method comprises:
receiving, at the graphical user interface, player inputs from the user engaging with a level of the game to enable the game to determine when that level has been completed by the user and to generate first player data indicating the level of the game that the user is engaged with;
determining that the user is engaged with the second set of levels;
obtaining second player data associated with a second user engaged with the second set of levels, the second player data indicating the level of the second set of levels that the second user is engaged with;
displaying, on the graphical user interface, a visual representation of relative positions of the first user and the second user in the second set of levels based on the first player data and the second player data.

7. The method of claim 6, wherein a player progression database stores player data associated with the user and the second user, wherein the method further comprises accessing the player progression database to obtain the second player data.

8. The method of claim 7, wherein the method further comprises:
obtaining a user identifier of a social contact of the user, wherein the social contact is the second user;
obtaining the second player data stored in the player progression database in association with the user identifier of a social contact.

9. The method of claim 1, wherein the second set of levels is made available for access during a predefined time period only, wherein the method further comprises, in response to determining that the user has completed the first intersection level, determining that the second set of levels is currently available for access; wherein access is granted to the first level of the second set of levels in response to determining that the second set of levels is currently available for access.

10. The method of claim 1, wherein:
the first plurality of levels comprises a third intersection level, a third set of levels, and a fourth intersection level, wherein the third intersection level immediately precedes the third set of levels and the fourth intersection level immediately succeeds the second set of levels; and
the second plurality of levels comprises a fourth set of levels, the fourth set of levels being playable in a predetermined order, wherein the fourth set of levels is provided in parallel to the third set of levels;
wherein access to the fourth intersection level is granted on completion of either the third set of levels or the fourth set of levels;
wherein the method further comprises:
determining that the user has completed the third intersection level;
in response to determining that the user has completed the first intersection level:
granting access to a first level of the third set of levels;
determining that the user has completed the second set of levels; and
in response to determining that the user has completed the second set of levels,
granting access to a first level of the fourth set of levels; and
displaying, on the graphical user interface, at least a portion of the fourth set of levels.

11. The method of claim 10, wherein the second set of levels is made available for access during a first predefined time period only, wherein the fourth set of levels is made available for access during a second predefined time period only, wherein the second predefined period is shorter than the first predefined time period and the second predefined time period overlaps with the first time period, wherein the method further comprises, in response to determining that the user has completed the first intersection level, determining that the second set of levels is currently available for access; wherein access is granted to the first level of the second set of levels in response to determining that the second set of levels is currently available for access.

12. The method of claim 1, wherein the first plurality of levels comprises a set of episodes, each episode comprising a predefined number of levels and playable in a predefined order, wherein a first episode comprises the first intersection level, the first set of levels, and the second intersection level, wherein a second episode comprises a third intersection level, a third set of levels, and a fourth intersection level, wherein the third intersection level immediately precedes the third set of levels and the fourth intersection level immediately succeeds the third set of levels, wherein the method further comprises:
determining that the user has completed the third intersection level;
in response to determining that the user has completed the third intersection level:
granting access to a first level of the third set of levels;
determining that the user has not completed the second set of levels and, in response, granting access to at least one level of the second set of levels; and
displaying, on the graphical user interface, at least a portion of the second set of levels.

13. The method of claim 12, wherein the method further comprises, in response to determining that the user has not completed the second set of levels:
determining a highest level of the second set of levels completed by the user, wherein a highest level of the set of levels is the level of the set of levels which is accessible last in the sequence of levels; and
granting access to a level of the second set of levels immediately succeeding the highest level of the second set of levels completed by the user.

14. The method of claim 1, wherein the method further comprises:
receiving a user interaction at the graphical user interface with one of the levels of the second set of levels;
determining that access has been granted to the level with which the user has interacted; and
in response to determining that access has been granted, providing a game level associated with the level at the graphical user interface.

15. The method of claim 14, wherein the method further comprises:
determining a difficulty bracket based on a highest level of the first plurality of levels to which the user has been granted access; and
modifying a difficulty level of the game level based on the difficulty bracket;
wherein the game level is provided at the graphical user interface with the modified difficulty level.

16. A computer device configured to provide a computer implemented game, the computer device comprising a display, a user interface, at least one memory, and at least one processor, wherein the game comprises:
a first plurality of levels comprising a first intersection level, a first set of levels, and a second intersection level, wherein the levels of the first plurality of levels are playable in a predetermined sequence, wherein the first intersection level immediately precedes the first set of levels and the second intersection level immediately succeeds the first set of levels;
a second plurality of levels comprising a second set of levels, the second set of levels being playable in a predetermined order, wherein the second set of levels is provided in parallel to the first set of levels;
wherein access to the second intersection level is granted on completion of either the first set of levels or the second set of levels;
wherein the at least one processor is configured to:
determine that a user has completed the first intersection level;
in response to determining that the user has completed the first intersection level, grant access to a first level of the first set of levels and a first level of the second set of levels; and
display, on the graphical user interface, at least a portion of the second set of levels.

17. A non-transitory computer program product comprising instructions which, when implemented by a at least one processor, cause a computing device to be configured to control a graphical user interface of the computing device, wherein the graphical user interface is associated with a game being executed by a processor of the computer device, wherein the game comprises:
a first plurality of levels comprising a first intersection level, a first set of levels, and a second intersection level, wherein the levels of the first plurality of levels are playable in a predetermined sequence, wherein the first intersection level immediately precedes the first set of levels and the second intersection level immediately succeeds the first set of levels;
a second plurality of levels comprising a second set of levels, the second set of levels being playable in a predetermined order, wherein the second set of levels is provided in parallel to the first set of levels;
wherein access to the second intersection level is granted on completion of either the first set of levels or the second set of levels;
wherein the computer program product causes the computing device to:
determine that a user has completed the first intersection level;
in response to determining that the user has completed the first intersection level, grant access to a first level of the first set of levels and a first level of the second set of levels; and
display, on the graphical user interface, at least a portion of the second set of levels.
